(19) United States
(12) Patent Application Publication
(10) Pub. No.: US 2009/0001000 A1
(43) Pub. Date: Jan. 1, 2009

(54) APPARATUS FOR TREATING LIQUID WASTE MATERIAL

(75) Inventors: Doug Pullman, Watford (CA); Roger H. Woods, Watford (CA)

Correspondence Address: MERCHANT & GOULD PC, P.O. BOX 2903, MINNEAPOLIS, MN, 55402-0903, US

(73) Assignee: Roger H. Woods Limited, Watford (CA)

(21) Appl. No.: 12/171,675

(22) Filed: Jul. 11, 2008

Related U.S. Application Data
(62) Division of application No. 11/040,904, filed on Jan. 21, 2005, now abandoned.
(60) Provisional application No. 60/538,219, filed on Jan. 23, 2004.

(51) Int. Cl. B01D 21/24

(52) U.S. Cl. 210/113; 210/151; 210/195.1

(57) ABSTRACT

An apparatus for treating liquid waste material includes first adding a chemical flocculent to the liquid waste material followed in a mixer to promote flocculation. The floc material is subsequently separated to produce a bulk clarified liquid, with the floc material being subjected to a solids separator to extract further bulk clarified liquid. The collected bulk clarified liquid is then recycled back in a recycle loop into at least one of the steps of adding a chemical flocculent and solids separation of the floc material. The apparatus is suitable for use with a wide variety of liquid waste materials ranging from agricultural and human waste to industrial waste. An apparatus for treating liquid waste material is also provided.

### CROSS-REFERENCE TO RELATED APPLICATIONS

This application is a Divisional application of application Ser. No. 11/040,904, filed Jan. 21, 2005, which claims the benefit of U.S. Provisional Patent Application No. 60/538,219 filed on Jan. 23, 2004 and which application(s) are incorporated herein by reference.

### FIELD OF THE INVENTION

The present invention relates to a process and apparatus for treating liquid waste material.

### BACKGROUND OF THE INVENTION

There is tremendous concern regarding waste management and its impact upon the environment. This concern spans a large number of industries, but is particularly evident with respect to high density animal farming, especially as urban development moves outward towards rural areas. One form of waste management that has come under heavy criticism is the application of agricultural and municipal biological liquid waste to agricultural land. While this practice offers farmers and municipalities a cost-effective means to dispose of waste material, with increasing opposition, cost effective environmentally-conscience alternatives must be developed.

A number of technologies address the issue of waste management and/or treatment. In U.S. Pat. No. 4,303,532 to Smelley et al., a process for dewatering slimes is disclosed. The process involves the admixing of a flocculating agent with a slime to be treated such as a phosphate slime, with subsequent floc removal via mechanical separation.

In U.S. Pat. No. 4,765,908 to Monick et al., a composition is disclosed which forms a non-leachable sludge when added to industrial wastewater. A process for using the composition is also disclosed, which can be arranged for either batch or continuous flow. The composition is added to wastewater in a mixing tank, stirred, and the resulting floc or sludge is collected using a belt filter. Alternatively, the sludge can be separated from the liquid fraction using a centrifuge.

In U.S. Pat. No. 6,261,459 to Waldmann, a process for the elimination of livestock wastewater odors and wastewater treatment is disclosed. The process comprises chemical modification of the wastewater with subsequent multiple solids separation steps.

In U.S. Pat. No. 6,447,686 to Choi et al., a high-speed coagulant-flocculent and sedimentation method is disclosed for the treatment of wastewater. The treatment process uses a mixing tank/agitation tank/polymer aggregation tank arrangement followed by solids separation in a sedimentation tank. The removed sludge can be recycled for use in porous ceramics.

While these technologies address in part the issue of waste treatment, in order for a liquid waste treatment process to be a feasible option, the liquid waste treatment process must be cost effective, flexible allowing for different types of liquid waste material to be handled, and minimally intrusive to current operations. As will be appreciated, there is clearly a need for a liquid waste treatment system offering portability, cost effective operation, and suitability for a wide range of liquid waste material ranging from agricultural to industrial.

It is therefore an object of the present invention to provide a novel process and apparatus for treating liquid waste material.

### SUMMARY OF THE INVENTION

Broadly stated, the present invention provides a multiple stage liquid waste material treatment process and apparatus incorporating a recycle feature for enhancing the overall treatment process and apparatus.

In accordance with one aspect of the present invention, there is provided a process for treating liquid waste material comprising:

a) adding a chemical flocculent to the liquid waste material;

b) mixing the flocculent-treated waste material to promote flocculation;

c) separating floc material from the flocculent-treated waste material to produce a bulk clarified liquid;

d) subjecting the floc material to solids separation to extract additional bulk clarified liquid; and

e) recycling bulk clarified liquid back into at least one of steps a and d.

In one embodiment, the bulk clarified liquid is collected from steps c and d prior to recycling. The process may also include additional steps prior to the addition of the chemical flocculent. For example, the process may include an initial step of separating larger solids from the liquid waste material by way of passing the liquid waste material through a vibratory screen separator, or similar separating mechanism. In certain cases, it may be advantageous to subject the liquid waste material to a precleaning step to remove salts and/or other readily removed components. A further design option is to provide ozonation with or without subsequent gas stripping to remove ammonia and/or other off-gases.

During the process the bulk clarified liquid may be recycled to the liquid waste material prior to adding the chemical flocculent. The bulk clarified liquid may also be recycled to the additional separating and/or cleaning step preceding flocculation. In this case, bulk clarified liquid is recycled prior to adding the chemical flocculent to the liquid waste material, during addition of the chemical flocculent to the liquid waste material and during solids separation.

In accordance with another aspect of the present invention, there is provided an apparatus for treating liquid waste material comprising:

a mixer receiving liquid waste material and mixing a chemical flocculent into the liquid waste material;

a floc separator in fluid communication with an outlet of the mixer, the floc separator separating floc material from the flocculent-treated liquid waste material to produce a bulk clarified liquid;

a solids separator in fluid communication with the floc separator to extract additional bulk clarified liquid from the floc material; and

a recycle loop recycling bulk clarified liquid into at least one of said mixer and solids separator.

In accordance with yet another aspect of the present invention, there is provided an apparatus for extracting bulk clarified liquid from a flocculent-treated liquid waste comprising:

a tank receiving a flow of flocculent-treated liquid waste, the tank having an outlet for removal of heavier-than-liquid floc material;

a floc collector within the tank, the floc collector having an outer peripheral wall with a top end positioned to coincide approximately with a predetermined fill limit of the tank, the floc collector having a collection area positioned within the peripheral wall below the top end for receiving lighter-than-liquid floc that overflows into the floc collector, said floc collector having an open bottom end, defining an interior space of reduced fluid turbulence within the floc collector in which clarified liquid collects; and

means for extracting clarified liquid from the interior space of the floc collector.

Advantageously, the liquid waste material process and apparatus can be operated in a continuous mode, allowing for the processing of liquid waste material on a real-time basis. This has the particular advantage of reducing the infrastructure necessary to collect and store the liquid waste material as compared to batch-style operations. Regular processing of the liquid waste material also serves to reduce odors associated with the liquid waste material, as the time the liquid waste material sits idle in pits and lagoons is reduced. Odor associated with livestock farming is a contentious issue, especially as urban development spreads into rural communities.

The separation of the liquid waste material into a solids fraction and a liquid fraction has the potential for the creation of value added products. With respect to animal waste, the solids fraction may find application as a nutrient supplement for fertilizer in agriculture. The removal of the liquid component reduces the likelihood of run-off into ground or surface waters. In turn, the liquid fraction may be used for a number of purposes, including pen cleaning/washdown and irrigation.

Another advantage is that the bentonite clay used in the process is a naturally occurring material that has the natural effect of encapsulating waste contaminants, reducing the rate at which contaminants are recycled back into the environment.

In addition, the apparatus is designed for compactness, allowing for trailer mounting and therefore, portability. The apparatus can be readily moved to locations requiring the treatment of liquid waste material. Within the agricultural sector, the apparatus can be moved around to different locations on one farm, with the expanded possibility of multi-farm cooperation. In oil field or mining operations, the apparatus can be moved to a waste lagoon or holding reservoir, thus reducing the need for costly transport and accompanying regulatory approvals. To promote ease of use and successful operation, the design of the apparatus is simple and straight-forward. Operator time for preparation, mobilization/demobilization, setup, operating and clean up are reduced.

### BRIEF DESCRIPTION OF THE DRAWINGS

Embodiments will now be described more fully with reference to the accompanying drawings in which:

FIG. 1 is a schematic drawing of an apparatus for treating liquid waste material;

FIG. 2 is a perspective view of a vibrating screen separator forming part of the apparatus of FIG. 1; and

FIG. 3 is a schematic drawing of another embodiment of an apparatus for treating liquid waste material.

### DETAILED DESCRIPTION OF THE EMBODIMENTS

In the following description, embodiments of an apparatus and process for treating liquid waste material are described. The liquid waste material treatment process involves various mechanical separations to separate solids components of the liquid waste material from the liquid fraction thereof, with the addition of a chemical treatment step to promote flocculation of suspended/colloidal matter or dissolved solids. Liquid waste material passed through the apparatus is ultimately separated into a solids fraction portion and an extracted liquid fraction portion.

The liquid waste material treatment process generally comprises four (4) stages making use of mechanical and/or chemical separation technologies. During stage one, incoming liquid waste material undergoes pretreatment to prepare the liquid waste material for flocculation. This stage may include one or any combination of steps including, but not limited to initial solids separation, pre-cleaning, ozonation with or without off-gas stripping and any other suitable pre-treatment process necessary to condition the liquid waste material for further treatment. If the incoming liquid waste material is relatively clear of large particulate matter or generally considered clean enough to proceed directly to flocculation, stage one may be skipped or bypassed. At stage two, a chemical flocculent is added to the partially clarified liquid waste material stream to facilitate extraction of suspended/colloidal matter or dissolved solids. This flocculent-treated liquid waste material stream is subsequently mixed to promote flocculation. Stage three involves producing a bulk clarified liquid by separating any resultant floc material from the flocculent-treated liquid waste material. During stage four, the floc material from stage three undergoes a further solids separation step to extract additional bulk clarified liquid retained within the collected floc material. To enhance the liquid waste material treatment process, the bulk clarified liquid collected in stages three and four is recycled back into the process at various introduction points, where deemed to be necessary. For the following discussion, the term liquid waste material is also meant to include waste materials that have been liquefied (i.e. diluted) prior to treatment.

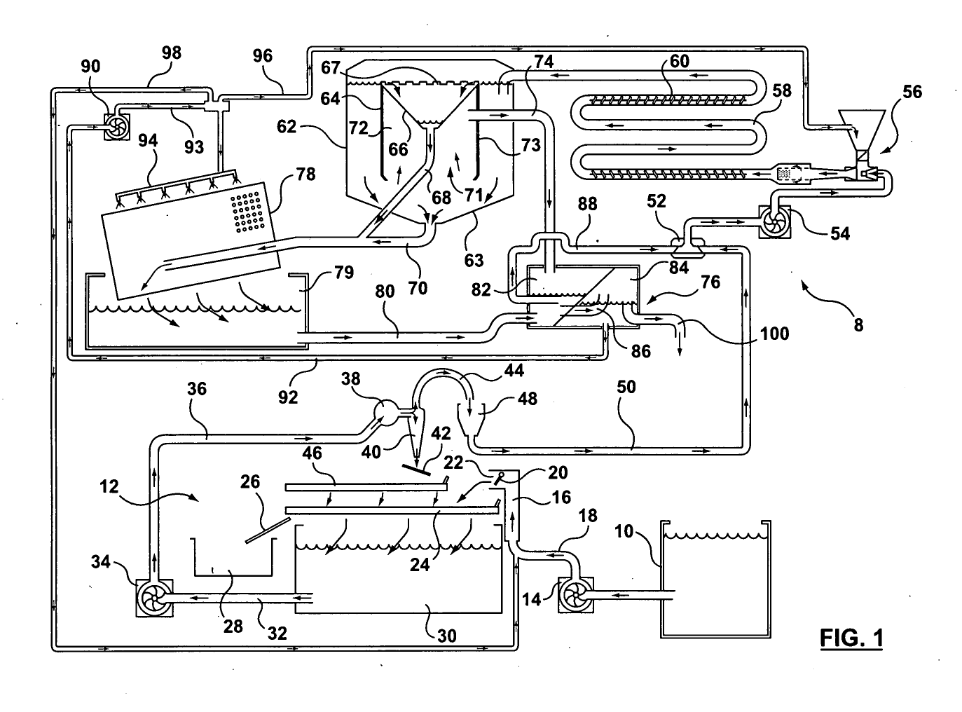

The present invention provides an effective real-time liquid waste material treatment process that can be operated continuously, as opposed to batch operation. Considering the variable nature of liquid waste material, the liquid waste material treatment process can most advantageously be adjusted to accommodate the specific characteristics of the liquid waste material being treated. The liquid waste material treatment apparatus is designed to be sufficiently compact to allow mounting on a trailer. This allows the apparatus to be used on-site, close to the source, thus reducing the need for costly transport, as well as reducing the inherent hazards and regulatory approvals associated with waste transport. An embodiment of the apparatus and process for treating liquid waste material will now be described with reference to FIG. 1.

Turning now to FIG. 1, an apparatus for treating liquid waste material is shown and generally identified by reference numeral 8. Liquid waste material is generally collected and stored in a holding container 10 such as for example, a lagoon, pit or tank. The liquid waste material may originate from a variety of sources including liquid animal manure, human waste water and industrial waste water (i.e. oil drilling, pulp and paper, coal fines/tailings, etc.). The apparatus 8 includes a plurality of stages through which liquid waste material is passed including a pre-treatment step that performs initial solids separation. The initial solids separation stage, if required, serves to remove larger solid components from the liquid waste material. As can be seen, the initial solids separation includes a vibrating screen separator 12. Vibrating screen separator 12 removes larger solid material from the liquid waste material by cycling the liquid waste material through a series of hydro-cyclone separators and vibrating screens. Larger solid matter is captured by the vibrating screens, with the ultimate output of the initial solids separation stage being a partially clarified liquid waste material stream.

More specifically, the liquid waste material is pumped from the holding container 10 by a pump 14 into a distribution box 16, via an inlet hose 18. Pump 14 in this example is a submersible pump, but it will be appreciated that one skilled in the art may choose to use an alternate suitable pump to deliver the liquid waste material to the distribution box 16. The distribution box 16 is an elongate distribution chamber which spans the width of the vibrating screen separator 12, to ensure an equal distribution of the liquid waste material across the separator. The liquid waste material exits the distribution box 16 through one or more regulating gates 20, mounted internal of but adjacent to the outlet 22 of the distribution box 16. The discharged liquid waste material, exiting through the outlet 22, falls upon a first vibrating shaker screen deck 24 which carries out an initial solids separation of the liquid waste material. Solids unable to pass through the deck 24 are retained, ultimately vibrating or “walking” off the end of the deck 24 into a spill chute 26, from where the solids are deposited into a storage container 28. The liquid waste material passing through the deck 24 is retained by a holding tank 30 positioned below the deck 24. The holding tank 30 is a large, open top rectangular tank, but any suitable liquid collection means may be used to collect the liquid waste material that passes through the deck 24.

From the holding tank 30, the liquid waste material passes through a conduit 32 into a pump 34 which delivers the liquid waste material via a conduit 36 into a pressurized controlled, sealed manifold 38. Pump 34 in this example is a centrifugal pump, however, it will be appreciated that one skilled in the art may choose to use any suitable pump type that achieves the necessary vacuum to enable liquid waste material delivery from the tank 30 to the manifold 38. The liquid waste material then exits the manifold 38 into a bank of cyclonic separators 40, operating in parallel. Each cyclonic separator 40 separates the liquid waste material into two liquid waste material streams, the first liquid waste material stream containing larger particulate matter, and the second liquid waste material stream containing smaller particulate matter. The first liquid waste material stream exiting each cyclonic separator 40 is directed onto a weir plate 42, while the second liquid waste material stream exiting each cyclonic separator 40 is directed into a conduit 44.

From the weir plate 42, the liquid waste material stream including concentrated particulates is deposited onto a second vibrating shaker deck 46, which is configured with finer screen characteristics than the first deck 24. As in the case of the first vibrating shaker screen deck 24, solids unable to pass through the deck 46 are retained, ultimately vibrating or “walking” off the end of the deck 46 into spill chute 26, from where the solids are deposited into the storage container 28. The deck 46 is positioned directly above the deck 24, thus recycling liquid waste material that passes through the deck 46. This localized recycling of the liquid waste material from the second deck 46 onto the first deck 24 serves to dilute the incoming liquid waste material delivered upon the deck 24, while also helping to reduce any buildup upon the first deck 24 of screened particulates.

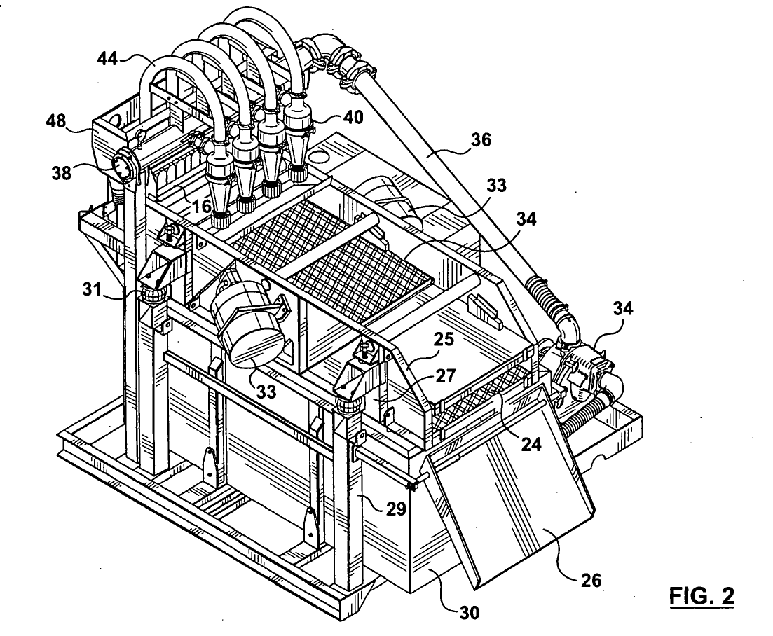

FIG. 2 better illustrates the vibrating screen separator 12 and as can be seen, the first and second vibrating shaker decks 24, 46 are supported by a common frame 25. The frame 25 includes vertical supports 27, which attach to a base 29 via spring mounts, air bags or dampeners 31. A conventional motor arrangement drives the frame 25 in a reciprocating vibratory motion. The motor arrangement comprises two hydraulically-driven counterweights (vibrators) 33, mounted to the frame 25.

The vibrating screen separator 12 can be adjusted, depending upon the characteristics of the liquid waste material being treated. The angles of the decks 24 and 46 can vary for example from about +5° to about −5°. Also, the mesh size of the screens of decks 24 and 46 can be varied. For example, the screen of deck 24 can vary from 10 mesh to 300 mesh and the screen of deck 46 can vary from 11 mesh to 400 mesh, with the screen of deck 46 having a finer mesh than the screen of deck 24.

The second liquid waste material stream fed to each conduit 44 is delivered to a collection trough 48 and combined yielding a partially clarified liquid waste material stream. From the collection trough 48, the partially clarified liquid waste material stream is pumped by means of a pump 54 through a conduit 50 to the second stage of the apparatus 8. While the pump 54 selected is of the centrifugal type, any suitable type that achieves the necessary vacuum for liquid delivery can be implemented.

At the second stage, the partially clarified liquid waste material stream is optionally diluted at a dilution valve 52 with recycled bulk clarified liquid, a feature that will be discussed further below. The partially clarified liquid waste material stream, whether diluted or not, is directed through a mixing apparatus 56 of the type disclosed in U.S. Pat. No. 5,779,355 to Pullman. At the mixing apparatus 56, a chemical flocculent is added to the partially clarified liquid waste material stream to promote flocculation of suspended/colloidal solids. The formulation of the flocculent generally comprises clays (i.e. bentonite clays), polymers and pH adjusters, and may contain several other additives such as hydrated lime, alum and calcium chloride. The formulation can be adjusted to target certain chemical constituents (i.e. heavy metals, trace pharmaceuticals, nitrogen/phosphorous/potassium, etc.). The mixing apparatus 56 is designed for effective and efficient introduction of a powdered flocculent into the partially clarified liquid waste material stream. Alternatively, the mixing apparatus 56 may be substituted with any suitable equivalent capable of effectively delivering either a flocculent slurry (liquid) mixture, or a powered flocculent to the partially clarified liquid waste material stream.

After the addition of flocculent, the flocculent-treated liquid waste material stream passes through a shearing tube 58 within which are positioned shearing plates 60 to promote mixing. The shearing plates 60 may be of any suitable configuration (i.e. circular, half-round, triangular, etc.) and are mounted on a central rod support structure, although alternate support means can be implemented. To achieve the necessary retention time, the shearing tube 58 may range in length from less than 25 feet to more than 500 feet, depending on the application. The diameter of the shearing tube 58 is generally 3 to 5 inches, but larger or smaller diameters may be implemented depending on the application and characteristics of the liquid waste material to be treated. The quantity of shearing plates 60 and the spacing therebetween can be adjusted to suit the particular application. The shearing tube 58 may be configured to serpentine back and forth within a suitable support structure, or it may be wrapped around the outer wall of a circular retention tank. The target in adjusting the various parameters is to achieve a stable floc that subsequently separates from the liquid phase. Alternatively, one skilled in the art may chose to add or substitute the above with a suitable alternative capable of achieving the desired floc characteristic (i.e. a static mixer).

From shearing tube 58, the flocculent-treated liquid waste material stream is transferred to the third stage of the apparatus, which generally comprises a floc separator 62, designed to extract bulk clarified liquid from the flocculent-treated liquid waste material stream. The floc separator 62 comprises a tank 63 receiving the flocculent-treated liquid waste material stream from the shearing tube 58. The flocculent-treated liquid waste material stream is introduced in a manner to promote circulation around the peripheral wall of the tank 63. In the tank 63, heavier-than-liquid floc material sinks to the bottom, where it is removed through an outlet 70. To facilitate floc removal from the bottom of the tank 63, the bottom of the tank is tapered, or funnels towards the outlet 70. To avoid floc material from becoming “trapped” in the flow of the flocculent-treated liquid waste material stream in the tank 63, the tank may be fitted with wings or baffles to disrupt flow and promote settling of the floc material.

To promote further separation of the floc material from the flocculent-treated liquid waste material stream, tank 63 is provided with a floc collector 64. The floc collector 64 has a top end 67 positioned to coincide approximately with a predetermined fill limit of the tank 63. Within the floc collector 64, below the top end 67, there is positioned a collection area 66 that receives lighter-than-liquid floc overflowing into the floc collector 64. The collection area 66 is defined by a funnel-shaped structure having an outlet 68 to facilitate removal of the floc material from the floc collector 64. It can be appreciated, however, that a variety of alternative floc removal means could be implemented to remove floc collected in the collection area 66. To facilitate collection of the lighter-than-liquid floc material, the top end portion of the floc collector 64 is shaped with alternating ports or holes. The size of the ports or holes will be a factor of the flow rate chosen for the process. As shown in FIG. 1, the top end 67 of the floc collector 64 in this example is crenellated. Alternatively, the top end 67 may be smooth with the floc collector being positioned on an angle relative to the liquid surface, thus collecting floc by way of skimming the surface. To establish a zone of reduced fluid turbulence, the floc collector 64 may be configured with a side wall 73 having an open bottom end 71, with the side-wall 73 of the floc collector defining an interior space 72 therein. Within interior space 72, due to reduced fluid turbulence, there is further separation of heavier particulates from the flocculent-treated liquid waste material yielding a bulk clarified liquid. The resulting bulk clarified liquid in the interior space 72 is substantially cleansed and is subsequently transferred via a conduit 74 to a collection tank 76. To further remove small floc material from the bulk clarified liquid, the conduit 74 may optionally be fitted with an in-line filter (5 to 100 micron).

Conduits 68 and 70 direct separated floc material away from the collection area 66 and the floc separator 62, respectively. While conduits 68 and 70 are presented as separate means of removing separated floc material, the conduits may be nested within the area of the floc separator and configured with a valve to control flow in the respective conduits. Regardless of the conduit configuration, the floc material in conduits 68 and 70 are combined and subsequently delivered to the fourth stage of the apparatus. It can be appreciated that alternatively, conduits 68 and 70 may each separately deliver the floc material to the fourth stage.

As can be seen, the fourth stage includes a secondary solids separator 78 of the rotary drum-type as disclosed in U.S. Pat. No. 5,733,450 to Langner. It will be appreciated, however, that one skilled in that art may choose to use an alternate suitable solids separator. Secondary solids separator 78 separates the solids component of the floc material from the liquids component yielding further bulk clarified liquid. The bulk clarified liquid from the separator 78 is collected in a collection tank 79, and is subsequently directed via a conduit 80 to the collection tank 76. The resulting solids component from the separator 78 is ultimately collected and either discarded, or combined with the solids components in storage container 28.

As explained above, bulk clarified liquid collected at stages three and four of the apparatus 8 is received by the collection tank 76, which is subdivided into two regions, namely a first tank region 82 and a second tank region 84. The first tank region 82 receives bulk clarified liquid via conduit 74 from stage three, and via conduit 80 from stage four. Bulk clarified liquid from the first tank region 82 is able to pass through to the second tank region 84 by means of a conduit 86. This conduit 86 is positioned in spaced-apart relationship from the bottom wall of the first tank region 82 so as to avoid the transfer of particulates that may have settled on the bottom of the first tank region 82.

To enhance liquid waste material treatment, the bulk clarified liquid collected in the collection tank 76 is recycled back into the apparatus at various introduction points. From the first tank region 82 of the collection tank 76, a conduit 88 delivers bulk clarified liquid to the dilution valve 52 to dilute, if necessary, the partially clarified liquid waste material stream. Dilution at this point may be necessary in order to enhance the subsequent flocculation step. From the second tank region 84, conduit 92 feeds pump 90, delivering the bulk clarified liquid through conduit 93 to a spray bar assembly 94 over the secondary solids separator 78, providing a means for cleaning the separator 78. The pump 90 also delivers the bulk clarified liquid via conduit 96 to the mixing apparatus 56 thereby to assist in the proper flow of flocculent into the mixing apparatus 56 (i.e. acts as a bridge breaker). Alternatively, the bulk clarified liquid in conduit 96 could be used to dilute a flocculent slurry in cases where a slurry is delivered to the mixing apparatus 56. The pump 90 can also be used to deliver, via conduit 98, bulk clarified liquid back into conduit 18 to ensure the consistency of the liquid waste material permits the desired distribution of the liquid waste material across the vibrating screen separator 12. The recycling of the bulk clarified liquid allows for these types of adjustments, while also mitigating the need for an external water supply, reducing the overall operating cost of the apparatus.

The second tank region 84 of the collection tank 76 is further configured with an outlet 100 through which the bulk clarified liquid can be discharged. The bulk clarified liquid from this outlet 100 can be either discharged/transported to a suitable waste facility, used for irrigation purposes, or for other purposes. If further filtration and/or treatment of the bulk clarified liquid is necessary, the outlet 100 can be fitted with an appropriate filter or post-treatment system including ozonation.

To demonstrate the treatment capability of the present invention, exemplary data relating to liquid waste material treated using the apparatus 8 is presented in Table I below. The liquid waste material used originated from a swine farming operation. It is evident from Table I that the separation efficiencies for the various parameters tested are all very significant. In particular, removal efficiencies in excess of 90% are noted for dry matter, nitrogen and phosphorous. These findings are quite significant as it suggests that the treated liquid produced by the present invention is less likely to cause problems related to nutrient runoff when used, for example, for irrigation purposes.

TABLE 1
Test results for swine liquid waste material after 20
minutes and 40 minutes continuous run time.

| | | | |
|---|---|---|---|
| | | | Separation |
| Parameter | Influent¹ | Effluent | Efficiency² |

20 minutes:

| | | | | |
|---|---|---|---|---|
| Dry Matter | % | 4.24 | 0.32 | 92% |
| Nitrogen | % | 0.52 | 0.04 | 92% |
| Phosphorus | % | 0.20 | 0.00 | 100% |
| Potassium | % | 0.24 | 0.05 | 79% |
| Total Salts | mmho/cm | 24.30 | 6.71 | 72% |
| Ammonium-N | ppm | 3410.00 | 467.00 | 86% |

40 minutes:

| | | | | |
|---|---|---|---|---|
| Dry Matter | % | 4.63 | 0.34 | 93% |
| Nitrogen | % | 0.57 | 0.05 | 91% |
| Phosphorus | % | 0.20 | 0.00 | 100% |
| Potassium | % | 0.24 | 0.06 | 75% |
| Total Salts | mmho/cm | 24.50 | 8.03 | 67% |
| Ammonium-N | ppm | 3400.00 | 457.00 | 87% |

Note 1
Influent: Raw Swine Manure Raw-Agitated & Aerated
Note 2
Separation Eff = (Influent-Effluent)/(Influent) × 100 (%)

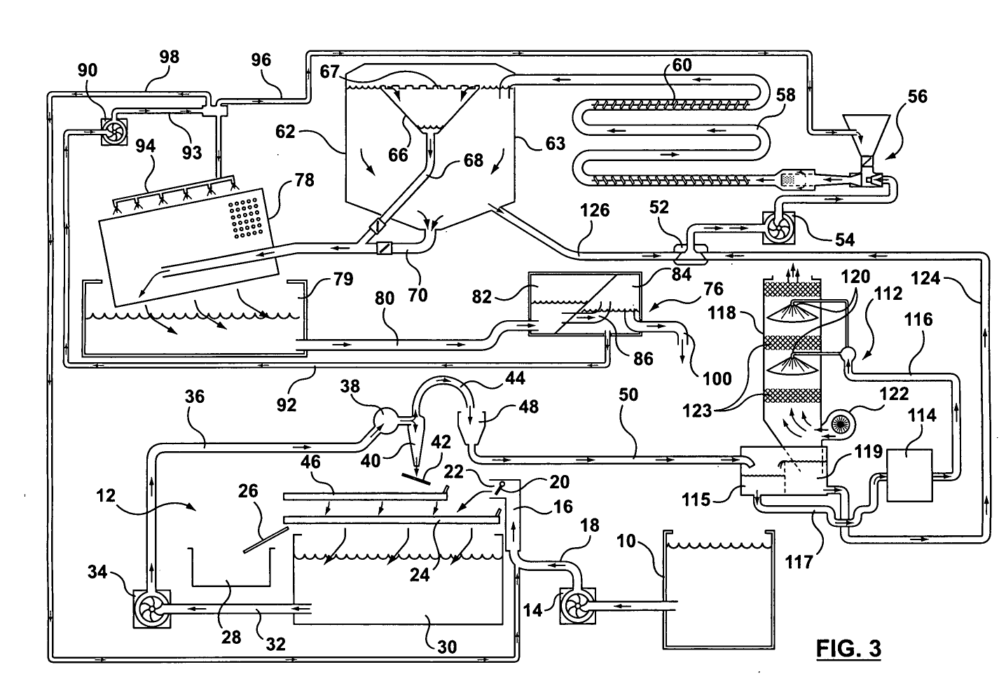

FIG. 3 shows an alternate embodiment of an apparatus for treating liquid waste material. Similar to the previous embodiment, the apparatus includes four stages of treatment, but with a number of design modifications. As shown, in this embodiment stage one incorporates two pretreatment steps comprising initial solids separation through vibrating screen separator 12, followed by an ozonation/stripping step 112. Partially clarified liquid waste material exiting the vibrating screen separator 12 by way of conduit 50 is directed to a first holding reservoir 115. From reservoir 115, the partially clarified liquid waste material is then pumped to ozone generator 114 via conduit 117. The pump may be an integral part of the ozone generator or may be provided separately. The ozonated liquid waste material stream is then directed through conduit 116 to an off-gas stripping tower 118. The off-gas stripping tower sprays the ozonated liquid waste material stream through nozzles 120 against a flow of air provided by blower 122, thus stripping from the ozonated liquid waste material stream of any off-gases (i.e. ammonia). The stripping tower 118 is provided with a medium 123 to increase the effective surface area within the structure, to promote additional removal of gases from the ozonated liquid waste material stream. The resulting pre-treated liquid waste material stream is then collected in reservoir 119 and sent via conduit 124 to dilution valve 52 for subsequent flocculation in mixing apparatus 56. The apparatus is also configured to enable a recycling of the ozone treatment, whereby reservoir 119 is configured to over-flow into reservoir 115, thus allowing a portion of the ozonated liquid waste material stream to mix with the incoming partially clarified liquid waste material. The extent of recycling through the ozonation/stripping step is controlled by means of setting a flow differential between conduits 116 and 124.

While the apparatus of FIG. 3 provides an initial solids separation and subsequent ozonation/stripping pretreatment, the process may include any combination of pretreatment steps necessary to condition the liquid waste material stream for flocculation. In the apparatus of FIG. 3, the floc separator 62 does not include side wall 73. In this configuration, the bulk clarified liquid is collected through conduit 126 and sent directly to dilution value 52, instead of collection tank 76, thus representing a dedicated dilution means with respect to the incoming partially clarified liquid waste material.

The present invention provides an apparatus and treatment process suitable for a wide variety of liquid waste materials ranging from agricultural and human wastes to industrial wastes (i.e. oil drilling waste, pulp and paper, coal fines/tailings, etc. . . . ). The apparatus and process can be tailored to accommodate the particular liquid waste material to be treated and provides a recycling feature to recycle bulk clarified liquid back into the process, reducing overall cost and the necessity of a supplemental water source.

Although preferred embodiments have been described, those of skill in the art will appreciate that variations and modifications may be made without departing from the spirit and scope thereof as defined by the appended claims.

What is claimed is:

1. An apparatus for treating liquid waste material comprising:
a mixer receiving liquid waste material and mixing a chemical flocculent into the liquid waste material;
a floc separator in fluid communication with an outlet of the mixer, the floc separator separating floc material from the flocculent-treated liquid waste material to produce a bulk clarified liquid;
a solids separator in fluid communication with the floc separator to extract additional bulk clarified liquid from the floc material; and
a recycle loop recycling a portion of said bulk clarified liquid into at least one of said mixer and solids separator.

2. The apparatus according to claim 1, further comprising a pretreatment stage for pretreating the liquid waste material before delivery to said mixer, said pretreatment stage comprising at least one of an initial solids separator, a pre-cleaner, an ozonator and an off-gas stripping tower.

3. The apparatus according to claim 1 further comprising an ozonator to treat discharged bulk clarified liquid.

4. The apparatus according to claim 2 comprising an additional recycle loop recycling a portion of said bulk clarified liquid into said pretreatment stage for pretreating the liquid waste material.

5. The apparatus according to claim 1 comprising an additional recycle loop delivering a portion of said bulk clarified liquid into said liquid waste material prior to delivery to said mixer.

6. An apparatus for extracting bulk clarified liquid from a flocculent-treated liquid waste comprising:
a tank receiving a flow of flocculent-treated liquid waste, the tank having an outlet for removal of heavier-than-liquid floc material;
a floc collector within the tank, the floc collector having an outer peripheral wall with a top end positioned to coincide approximately with a predetermined fill limit of the tank, the floc collector having a collection area positioned within the peripheral wall below the top end for receiving lighter-than-liquid floc that overflows into the floc collector, said floc collector having an open bottom end, defining an interior space of reduced fluid turbulence within the floc collector in which clarified liquid collects; and
means for extracting clarified liquid from the interior space of the floc collector.
